(19) United States
(12) Patent Application Publication
(10) Pub. No.: US 2008/0316027 A1
(43) Pub. Date: Dec. 25, 2008

(54) Security Alarm Blanket

(76) Inventor: Peter Lefferson, Saint Petersburg, FL (US)

Correspondence Address: PETER LEFFERSON, 6101 7 AVE. N., ST. PETERSBURG, FL, 33710-7015, US

(21) Appl. No.: 11/768,173

(22) Filed: Jun. 25, 2007

(51) Int. Cl. G01V 3/00

(52) U.S. Cl. 340/562

(57) ABSTRACT

A security alarm blanket can be placed over an object that is to be guarded. If someone approaches the blanket an audio, visual, and/or electronic alarm is sent. The blanket is made of a fabric with metal woven therein or a membrane material with a conductive surface and thus functions as the antenna for a proximity detector. The proximity detector may be activated from a remote controller allowing the operator the ability to prepare the object to be guarded and to deactivate the proximity detector without setting off the alarm.

### BACKGROUND OF INVENTION

We often have an object, display, piece of art, or even some dinner dessert that we would not want others to disturb. This invention solves that problem by providing a cover or small blanket to place over the object. If someone gets close to this cover an alarm is triggered. The alarm might be audio, visual, or a signal sent electronically to some other device such as a computer.

### SUMMARY OF INVENTION

In accordance with the present invention a security alarm blanket comprises a fabric with wires therein or a conductive membrane and an electronic proximity detection system. An object covered by this blanket is guarded by this security system that will alarm when someone approaches or touches the blanket.

### DRAWINGS

### Figures

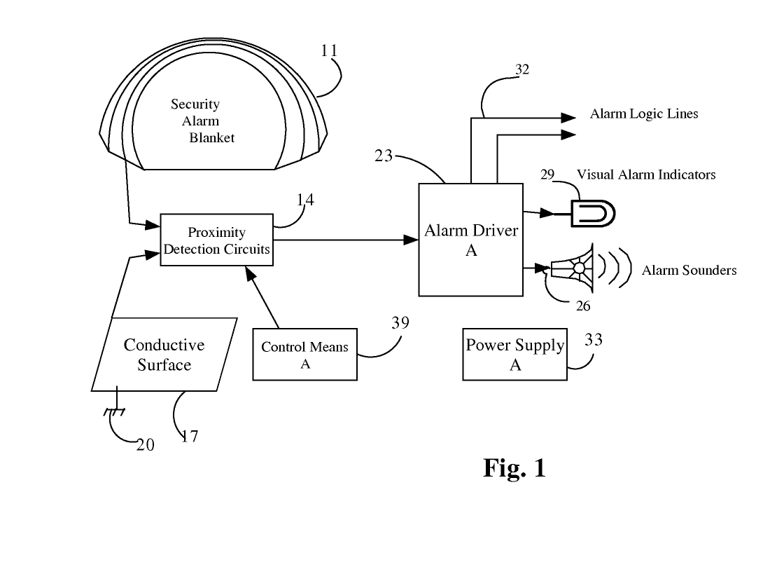

FIG. 1 shows a method to guard an object by draping a electric conductive blanket over an object to be secured. An alarm is generated when someone comes close to or touches the blanket.

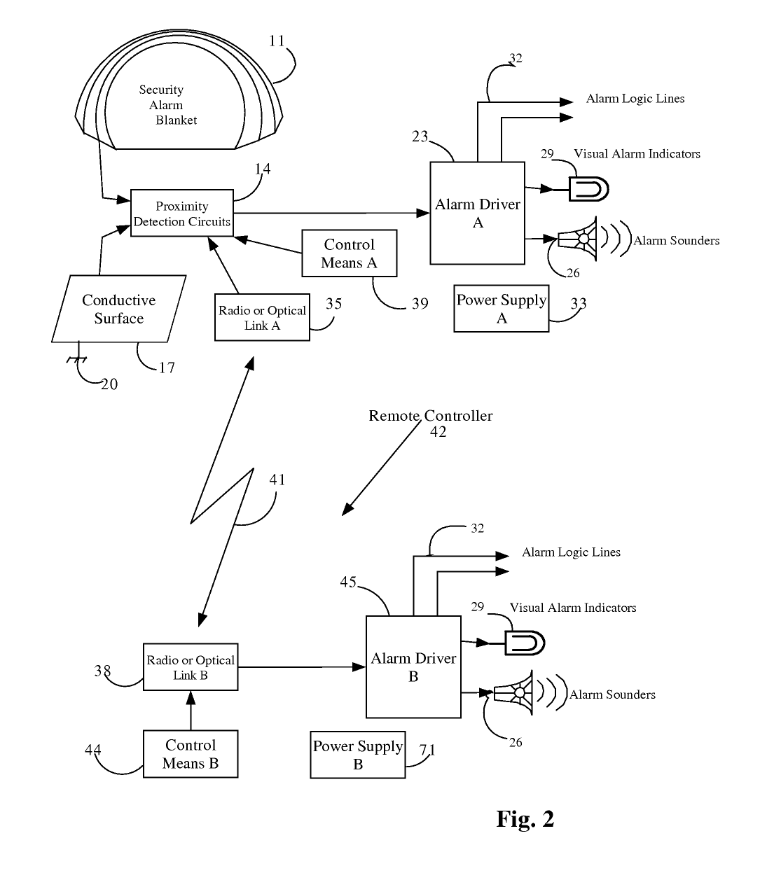

FIG. 2 shows the above method with addition of a remote controller so the operator can turn the proximity detector off before getting close to the security alarm blanket.

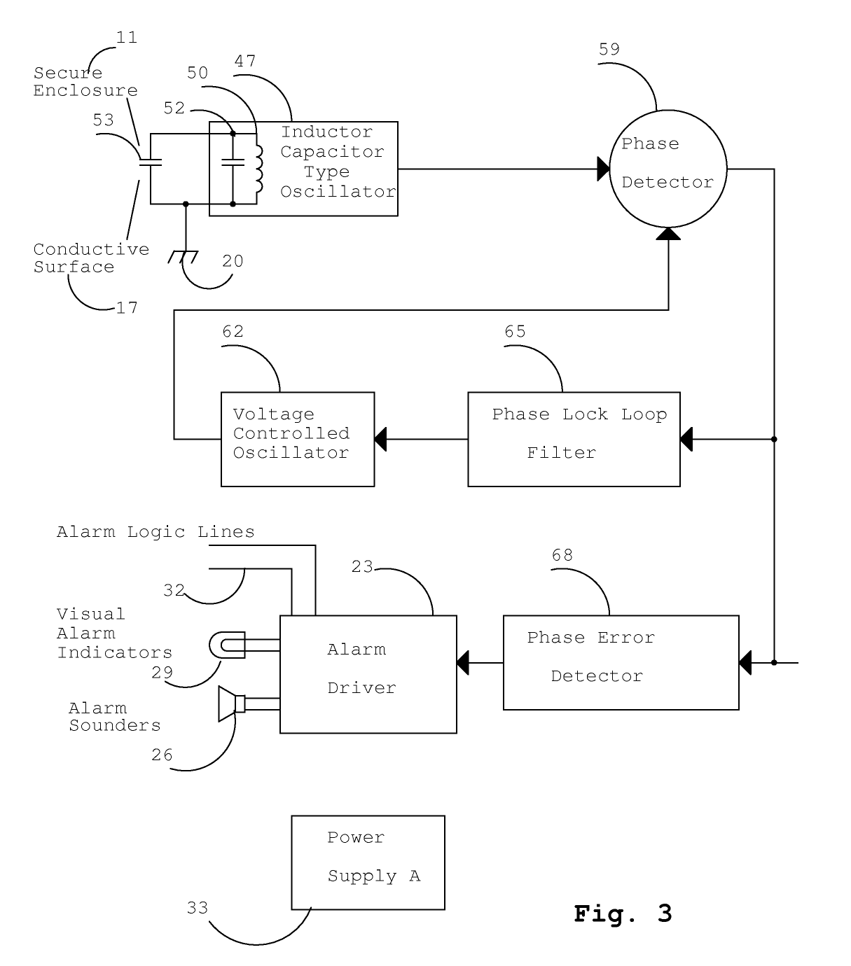

FIG. 3 shows inductor capacitor type oscillator within a phase lock loop as a preferred proximity detector. This is only one of many proximity detection circuit methods known by the industry.

### REFERENCE NUMERALS

11. security alarm blanket
14. proximity detection circuits
17. conductive surface
20. path to ground
23. alarm drivers
26. alarm sounders
29. visual alarm indicators
32. alarm logic lines
33. power supply A
35. radio or optical link A
38. radio or optical link B
39. control means A
41. link between controller and proximity detector
42. remote controller
44. control means B
45. alarm driver B
47. inductor capacitor type oscillator
50. resonating inductor
52. resonating capacitor A
53. resonating capacitor B
59. phase detector
62. voltage controlled oscillator
65. phase lock loop filter
68. phase error detector
71. power supply B

### DETAILED DESCRIPTION

FIG. 1 shows the basic security alarm blanket system where a cloth or membrane material 11 is placed over the object to be secured. The cloth or membrane material 11 is covered with a metallic surface or may have electrically conductive wires or screen embedded therein. The cloth or membrane material 11 becomes the antenna of a proximity detection system when so wired to a proximity detection circuit 14. The system is turned on and the sensitivity is set through a local control means 39. When the proximity detection circuit 14 is triggered by someone approaching the security alarm blanket 11 and alarm is generated and sent to the alarm driver A 23 and then on to an audio sounder 26 and/or a visual alarm indicator 29, and/or alarm logic lines 32 to some remote device. The system employs a power supply A 33 that may be battery or use the electrical mains.

In this embodiment the proximity detection circuit 14 may be of the capacitive type where there is a capacitance between the cloth like material and a second conductive surface 17. The second conductive surface 17 will be of sufficient size and be close enough to the security alarm blanket 11 for the proximity detection circuit 14 to function. The conductive surface 17 might also be the electrical mains ground 20. A person approaching the security alarm blanket 11 will change this capacitance and that change would generate the alarm.

FIG. 2. shows the same basic system as in FIG. 1 but with the additional feature of remote controller 42. There is a control means A 39 for local control at the security alarm blanket 11. There is also a control means B 44 that is now part of a remote control 42. Control of the proximity detection circuit 14 is now through radio or optical link A 35 and radio or optical link B 38 over a radio or optical path 41. The control means B 44 may include alarm on and off switches as well as controls for adjusting the sensitivity of the proximity detection circuit 14.

FIG. 2 also includes power supply A 23 to energize the system at the security alarm blanket 14. Power supply B 71 provides power to the remote controller 42. Either of these may use batteries or the electrical mains.

FIG. 2 shows alarm drive A 23 at the security alarm blanket 11 and alarm and alarm driver B 45 at the remote controller 42. This invention may include either or both of these.

FIG. 3 shows a preferred method to make the proximity detector using a phase lock loop (PLL). The PLL is an electronic control system that generates a signal that is locked to the phase of a reference signal. In this invention the voltage controlled oscillator (VCO) 62 is locked to the frequency and phase of a inductor capacitor type oscillator (LC Osc.) 47. The PLL circuit responds to both the frequency and the phase of the LC Osc. 47 and automatically raises or lowers the frequency of the VCO 62 until it matches to the LC Osc. in both frequency and phase.

The frequency of the LC Osc. 47 is defined by the value of the resonating components, inductor 50 and capacitor A 52 and capacitor B 53. Inductor 50 and capacitor A 52 are located within the electronic circuitry. Capacitor B 53 is actually the capacitance value between the conductive portions of the security alarm blanket 11 and the conductive surface 17. The conductive surface 17 may often be the actual ground near the secure enclosure 11 or it could be a metal plate or an extended wire.

When someone approaches the secure enclosure 11 the LC Osc. 47 frequency changes because the value of the capacitor B 53 has changed. The phase detector 59 immediately detects this as a phase shift and the error voltage is sent through the PLL filter 65 to the VCO 62. The PLL filter 65 has a long time response to the phase detector 59 phase error signal. Therefore the VCO 62 gradually comes to the frequency and phase of the LC Osc. 47. That large error signal from the phase detector 59 is detected phase error detector 68 as an alarm situation. Alarm driver 23 will then activate an alarm sounder 26, and/or a visual alarm indictor 29, and/or send an the alarm over alarm logic lines 32 to some location.

It will thus be seen that the objects set forth above, and those made apparent from the forgoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A security alarm blanket to cover an object to be guarded:
a. a proximity detection means that will send an alarm signal when it is triggered,
b. a proximity detection means that employs two capacitor plates as the proximity sensitive surface,
c. a membrane with an electrically conductive surface embedded therein that is coupled to said proximity detection means forming the proximity sensitive surface as one of the two plates of said capacitor for said proximity detection means,
d. an electrical grounding means that forms the other plate of said capacitor that is coupled to said proximity detection means,
e. said membrane becoming a blanket that can cover an object to be guarded,
whereby setting off an alarm if someone approaches said object.

2. A security alarm blanket of claim 1 wherein said electrical grounding means is a sheet of conductive material of sufficient area and location to make said proximity detection means work properly.

3. A security alarm blanket of claim 1 wherein said electrical grounding means is a wire of sufficient length to make said proximity detection means work properly.

4. A security alarm blanket of claim 1 wherein said electrical grounding means is provided by the electrical path to ground through an electrical power supply that is powered by the electrical power mains.

5. A security alarm blanket of claim 1 wherein there is a remote controller means whereby said proximity detection means can to enabled and disabled remotely.

6. A security alarm blanket to cover an object to be guarded:
a. a proximity detection means that will send an alarm signal when it is triggered,
b. a proximity detection means that employs two capacitor plates as the proximity sensitive surface,
c. a fabric with wires embedded therein that is coupled to said proximity detection means forming the proximity sensitive surface as one of the two plates of said capacitor for said proximity detection means,
d. an electrical grounding means that forms the other plate of said capacitor that is coupled to said proximity detection means,
e. said fabric becoming a blanket that can cover an object to be guarded,
whereby setting off an alarm if someone approaches said object.

7. A security alarm blanket of claim 6 wherein said electrical grounding means is a sheet of conductive material of sufficient area and location to make said proximity detection means work properly.

8. A security alarm blanket of claim 6 wherein said electrical grounding means is a wire of sufficient length to make said proximity detection means work properly.

9. A security alarm blanket of claim 6 wherein said electrical grounding means is provided by the electrical path to ground through an electrical power supply that is powered by the electrical power mains.

10. A security alarm blanket of claim 6 wherein there is a remote controller means whereby said proximity detection means can to enabled and disabled remotely.
